(19) United States
(12) Patent Application Publication
(10) Pub. No.: US 2026/0064460 A1
(43) Pub. Date: Mar. 5, 2026

(54) SCALABLE COMMAND QUEUEING APPARATUSES AND METHODS

(71) Applicant: UNTETHER AI CORPORATION, Toronto (CA)

(72) Inventor: Dustin T. GRIESDORF, Toronto (CA)

(21) Appl. No.: 18/825,392

(22) Filed: Sep. 5, 2024

(51) Int. Cl. G06F 9/48

(52) U.S. Cl. CPC G06F 9/4881

(57) ABSTRACT

A computing apparatus includes: a set of processing elements configured to execute an active command obtained from a plurality of commands; a first command queue; a second command queue; a bank controller configured to place respective subsets of the plurality of commands into the first and second command queues; and an array controller configured to: (i) select one of the first command queue and the second command queue, (ii) retrieve the active command from the selected one of the first command queue and the second command queue, and (iii) deploy the active command to each of the set of processing elements for execution.

### FIELD

The specification relates generally to executable command handling in computational systems, and specifically to scalable command queueing apparatuses and methods.

### BACKGROUND

Commands executed in a variety of computing apparatuses, such as coprocessors (e.g., graphics processing units or GPUs), primary processors (central processing units or CPUs), or the like, may be generated and executed sequentially. Certain commands may be obstructed from execution, e.g., due to a resource required for executing the commands being unavailable. To reduce the likelihood of an obstructed command preventing the execution of further commands until the required resource is available, the apparatus can deploy out-of-order execution and/or pre-emption processes, e.g., to predict future a state of the apparatus and sequence or re-sequence commands accordingly. The above processes, however, involve polling operations and/or additional computations and therefore scale poorly in systems with significant numbers (e.g., hundreds or more) of controllers.

### SUMMARY

Examples disclosed herein are directed to a computing apparatus including: a set of processing elements configured to execute an active command obtained from a plurality of commands; a first command queue; a second command queue; a bank controller configured to place respective subsets of the plurality of commands into the first and second command queues; and an array controller configured to: (i) select one of the first command queue and the second command queue, (ii) retrieve the active command from the selected one of the first command queue and the second command queue, and (iii) deploy the active command to each of the set of processing elements for execution.

Additional examples disclosed herein are directed to a method in a computing apparatus, the method including: at a bank controller of the computing apparatus, placing respective subsets of a plurality of commands into a first command queue and a second command queue of the computing apparatus; at an array controller of the computing apparatus: (i) selecting one of the first command queue and the second command queue, (ii) retrieving an active command among the plurality of commands from the selected one of the first command queue and the second command queue, and (iii) deploying the active command to each of a set of processing elements of the computing apparatus for execution; and at the set of processing elements, executing the active command.

### BRIEF DESCRIPTIONS OF THE DRAWINGS

Embodiments are described with reference to the following figures.

FIG. 1 is a diagram of a computing apparatus.

FIG. 2A is a diagram of a command queue configuration for the apparatus of FIG. 1.

FIG. 2B is a diagram of another command queue configuration for the apparatus of FIG. 1.

FIG. 3 is a flowchart of a method for scalable command handling.

FIG. 4 is a diagram illustrating an example performance of the method of FIG. 3.

### DETAILED DESCRIPTION

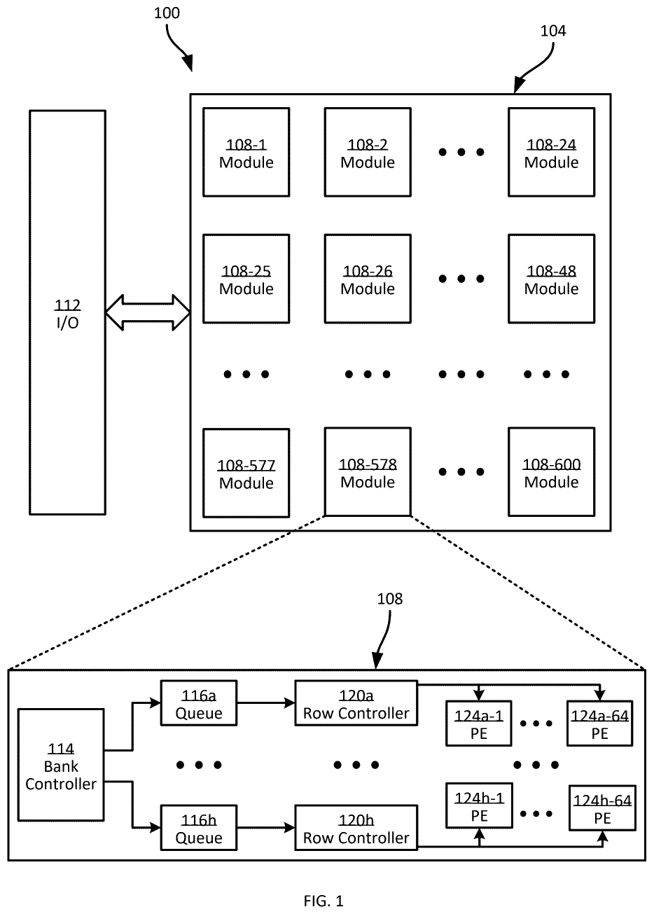

FIG. 1 depicts a computing apparatus 100, e.g., implemented in the form of an integrated circuit (e.g., a chip). The apparatus 100 can be deployed as a component of a coprocessor board configured to perform certain operations in a computing device such as a desktop computer, a server, or the like. In other examples, the apparatus 100 can be deployed as a primary processor (e.g., a central processing unit). In some examples, the apparatus 100 can be packaged with additional integrated circuit components, e.g., those components implementing further logic circuitry, storage, and the like.

The apparatus 100 includes an array 104 of computing modules 108, which can also be referred to as banks 108 and are illustrated with hyphenated suffixes in FIG. 1 to distinguish between individual modules 108. That is, each module 108 can be referred to with a corresponding suffix, such as the modules 108-1, 108-2, 108-24, 108-25, 108-26, 108-48, 108-577, 108-578, and 108-600 shown in FIG. 1. The modules 108 are referred to collectively or generically by omitting the suffix. The array 104 can include a wide variety of numbers of modules 108, e.g., depending on performance and/or cost constraints for the apparatus 100. In the illustrated example, the array 104 includes a total of six hundred modules 108, arranged in twenty-five rows of twenty-four modules 108 each. This arrangement is purely illustrative, and both the number of modules 108 and their physical arrangement in the array 104 can vary in other implementations.

Each module 108 includes various subcomponents for performing computations such as single-instruction, multiple data (SIMD) operations such as sets of multiply-accumulate operations. Example components of the modules 108 will be described below. The modules 108 can be interconnected with one another and/or with shared storage elements, e.g., via one or more communication buses (not shown). In addition, the array 104 is connected with one or more input/output modules 112, e.g., via one or more communication buses, for communicating with other computing apparatuses, other components of the above-mentioned coprocessor board, or the like. In some examples, the apparatus 100 can include more than one I/O module 112.

Example components of a module 108 are also shown in FIG. 1. Each module 108 includes a controller, also referred to as a bank controller 114. The bank controller 114 includes various internal components, such as cache memory, state information registers, I/O components, and the like. The bank controller 114 is configured to execute machine-readable programming instructions, e.g., retrieved from the above-mentioned cache and/or a memory element external to the bank controller 114. According to the execution of such instructions, the bank controller 115 is configured to generate commands defining operations (e.g., multiply-accumulate operations) to be performed within the module 108.

The module 108 also includes a plurality of additional processing components, e.g., arranged in linear arrays (e.g., rows), with each array connected with the bank controller 114. As shown in FIG. 1, the module 108 can include eight such rows, although in other embodiments the module 108 can include more or fewer rows than eight. Each row includes a queue 116 (thus, for example, the module 108 includes eight queues 116a through 116h), and a row controller 120 (and in this example, the module 108 includes eight row controllers 120a through 120h). The bank controller 114 is configured to place the commands mentioned above into the queues 116 according to any suitable row-selection logic implemented within the bank controller 114. Each row controller 120 is configured to retrieve a command from the corresponding queue 116 (e.g., the row controller 120a retrieves commands from the queue 116a), and deploy the retrieved command to an array of processing elements (PEs) 124. In this example, each row includes sixty-four PEs 124 (e.g., PEs 124a-1 through 124a-64 correspond to the row controller 120a, and PEs 124h-1 through 124h-64 correspond to the row controller 120h).

The PEs 124 in a given row are configured to execute a single, common command at a time, but each PE 124 can execute the command using different input data from the other PEs 124. Each PE 124 can include working memory and logical circuit(s) suitable for performing a range of operations, including at least multiply-accumulate operations as mentioned above. When the PEs 124 of a given row have completed execution of an operation, the results of the operation can be returned to the corresponding row controller 120, passed to PEs 124 of an adjacent row, or the like.

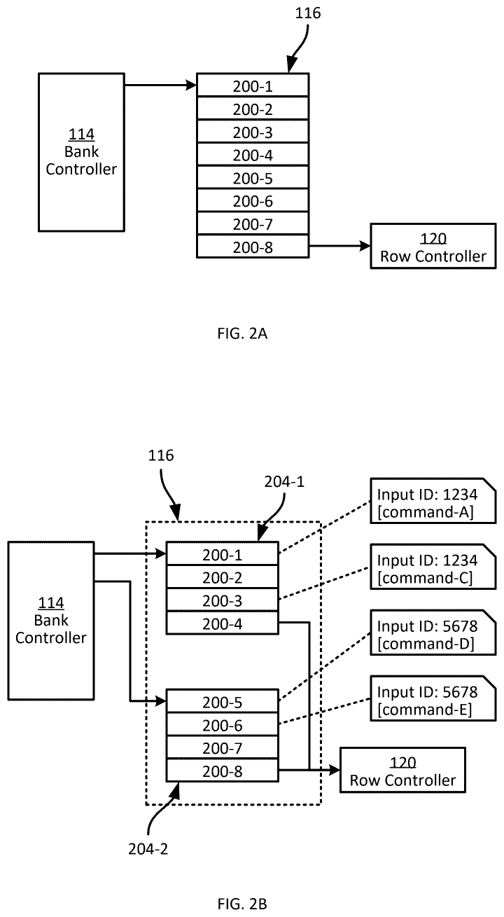

The queues 116 are provided to mitigate the impact of delays in command generation at the bank controller 114, e.g., in response to context switching when the bank controller 114 switches execution threads or the like. The structure and operation of the queues 116 are discussed in greater detail below, with reference to FIGS. 2A and 2B.

FIG. 2A illustrates an example queue structure, illustrating the bank controller 114 and one partial row, generically numbered (that is, without specific suffix numbers). The PEs 124 of the illustrated row are omitted from FIG. 2A for clarity, as are the other rows of computing components (e.g., the seven other rows, in this example). It will be understood that the queue structure shown in FIG. 2A can be reproduced for each row of the module 108. The bank controller 114 can write commands to an input port of the queue 116 (the bank controller 114 can therefore include sufficient output ports and/or other addressing infrastructure to selectively write to each queue 116).

Commands reaching the queue 116, which can include dedicated space in a memory, or a dedicated memory circuit distinct from other memory elements of the module 108, are stored for sequential retrieval by the row controller 120. The queue 116 is implemented to provide in-order execution of commands stored therein, such that the order in which commands are retrieved for execution by the row controller 120 matches the order the commands were written to the queue 116. This is illustrated in FIG. 2A by an input port providing commands to a portion 200-1 of the queue 116, and an output port retrieving instructions from a portion 200-8 of the queue 116. The commands may, for example, be shifted from the portion 200-1 through the portions 200-2 to 200-7, before being retrieved from the portion 200-8. The queue 116 can also be implemented to provide in-order command execution without shifting commands through specific portions 200 of the queue 116, however. For example, the queue 116 can include a register or other memory indicating a received order for the commands currently in the queue, e.g., defining a sequence of memory addresses for retrieval by the row controller 120.

While the arrangement shown in FIG. 2A mitigates downstream impacts (e.g., on the row controller 120 and PEs 124) of delays in command generation at the bank controller 114, the arrangement of FIG. 2A may also lead to suboptimal use of the row controller 120 and PEs 124 of the corresponding row. For example, if the next command in the sequence defined in the queue 116 is obstructed, e.g., because a resource involved in the execution for that command is not yet available, the row controller 120 is configured to wait until the obstruction is resolved before retrieving the command and deploying the command to the corresponding PEs 124. Because the commands in the queue are executed in order of receipt from the bank controller 114, however, the row controller 120 in the arrangement shown in FIG. 2A does not retrieve another command. Instead, the row controller 120, and therefore the PEs 124 managed by the row controller 120, may remain idle until the obstructed command becomes unobstructed (e.g., an input buffer or other resource involved in the execution of the next command changes state to satisfy execution conditions of the command).

Computing devices can resolve the occurrence of idle time due to obstructed commands by implemented processing thread preemption and/or out-of-order execution. For example, the bank controller 114 can poll the row controllers 120 and/or PEs 124, and predict future states of the computational resources available to the row controllers 120 and/or PEs 124. Based on such predictions, the bank controller 114 can sequence commands in the queues 116 in an effort to reduce the likelihood of obstruction-related idle time. Such sequencing may be performed by retrieving and re-writing commands in the queue 116, suspending execution of one processing thread in favour of another at the bank controller 114, or the like. The implementation of preemption and/or out-of-order execution, however, may involves provisioning the bank controller 114 and/or the row controller 120 with additional hardware, and may also involve additional computation cycles being committed to implementing preemption and/or out-of-order logic. The additional hardware resources, computation time, and resulting power consumption can be significant in a device such as the apparatus 100, where such additional resources are provided to hundreds or thousands of bank controllers 114.

To mitigate the impacts of obstructed commands, while also mitigating the need for additional hardware, computing cycles, or the like, the apparatus 100 can therefore include a modified queue 116, as shown in FIG. 2B.

In the implementation shown in FIG. 2B, the queue is implemented as a first queue 204-1, and a second queue 204-2. The queues 204 can be physically distinct memories (e.g., reserved address spaces, distinct memory circuits, or the like), each with an input port. The queue 116 can include a single output port (e.g., a single address used by the row controller 120 to retrieve commands), although in some examples the queue 116 can include one output port per queue 204. The queues 204 can, as shown in FIG. 2B, each have a smaller capacity than the queue 116 shown in FIG. 2A. In other examples, however, the queues 204 can be smaller or larger than shown in FIG. 2B. While the queues 204 are shown as having the same size as one another (four portions, each for storing one command), in other implementations the queues 204 may have different sizes.

Commands can be stored in the queues 204 along with an identifier of the input port the commands were received at. For example, commands “command-A” and “command-C” are both stored (in the portions 200-1 and 200-3, respectively) in association with the input identifier “1234”, e.g., corresponding to the input port of the queue 204-1. The commands “command-D” and “command-E” are stored (in the portions 200-5 and 200-6, respectively) in association with the input identifier “5678”, e.g., corresponding to the input port of the queue 204-2.

In this example, the row controller 120 can retrieve commands selectively from either the queue 204-1 or the queue 204-2 via the single output port associated with the queues 204, e.g., by specifying one of the two input ports (e.g., “1234” or “5678”) in a retrieval command. The queues 204-1 and 204-2 each output commands in the same sequence as those commands were received. That is, each queue 204 provides in-order command execution, but commands between the queues 204 need not be executed in a particular order relative to each other.

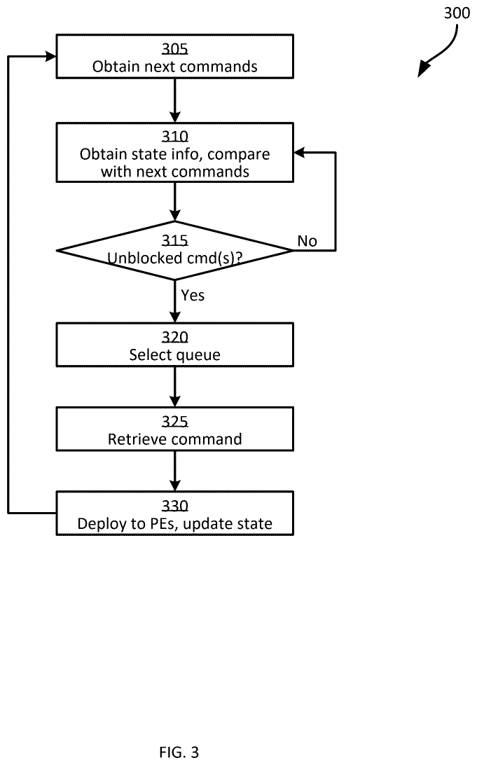

Turning to FIG. 3, a method 300 of scalable command handling is illustrated. The method 300 can be performed, in this example, by the row controller 120. As will be apparent, each row controller 120 can perform an independent instance of the method 300 (that is, independent from the other row controllers 120) to supply its PEs 124 with commands for execution. In other examples, however, some portions of the method 300 can be performed by another component disposed logically between the queues 204 and the row controller 120.

Through performance of the method 300, a given row controller 120 is configured to select one of the command queues 204-1 and 204-2 (or to select among a larger number of queues 204, when more than two queues 204 are implemented for a given row controller 120). The next command to be deployed to the PEs 124 for execution (also referred to as the active command) is then retrieved from the selected queue 204.

At block 305, the row controller 120 is configured to obtain candidate active commands from each queue 204. The candidate active command obtained from each queue 204 is the next command in that queue 204. The commands obtained at block 305 are not de-queued for execution, but are instead obtained for evaluation of whether the commands are currently obstructed. In some examples, obtaining a candidate active command need not include obtaining the entire contents of the command. For example, the row controller 120 can be configured to obtain one or more parameters of each candidate command, such as parameters identifying input resources for the command (e.g., an input buffer expected to contain data for executing the command).

At block 310, the row controller 120 is configured to obtain state information corresponding to execution resources associated with the set of processing elements 124 (that is, the array of PEs 124 that correspond to the row controller 120). The state information can indicate the state of each PE 124 in the relevant array of PEs 124, for example indicating whether a given PE 124 is idle or busy. The state information can also include, in some examples, indications of which specific resources within each PE 124 are busy or available (e.g., specific buffers or execution units). The state information can also, in some examples, indicate the state of resources external to the PEs 124 themselves, such as the state of an input buffer that is read from to execute a candidate command (e.g., whether the input buffer is empty).

The row controller 120 is further configured to compare the state information and the candidate commands at block 310. At block 315, the row controller 120 is configured to determine whether any of the candidate commands are unobstructed (also referred to as unblocked). A candidate command is unobstructed if the resources (e.g., PEs 124 or at least relevant units within the PEs 124, external input and/or output buffers, etc.) are available. In other words, an unobstructed command can be executed substantially immediately. A command is obstructed when any of the resources involved in executing the command are currently unavailable.

When the determination at block 315 is negative, indicating that all of the candidate commands obtained at block 305 are obstructed, the row controller 120 returns to block 310. When at least one of the candidate commands is unobstructed, however, the row controller 120 proceeds to block 320. At block 320, the row controller 120 is configured to select one of the queues 204 for which the corresponding candidate command is unobstructed. When a single candidate command is unobstructed (and the other candidate command(s) is/are obstructed), the row controller 120 is configured to select the queue containing the unobstructed command.

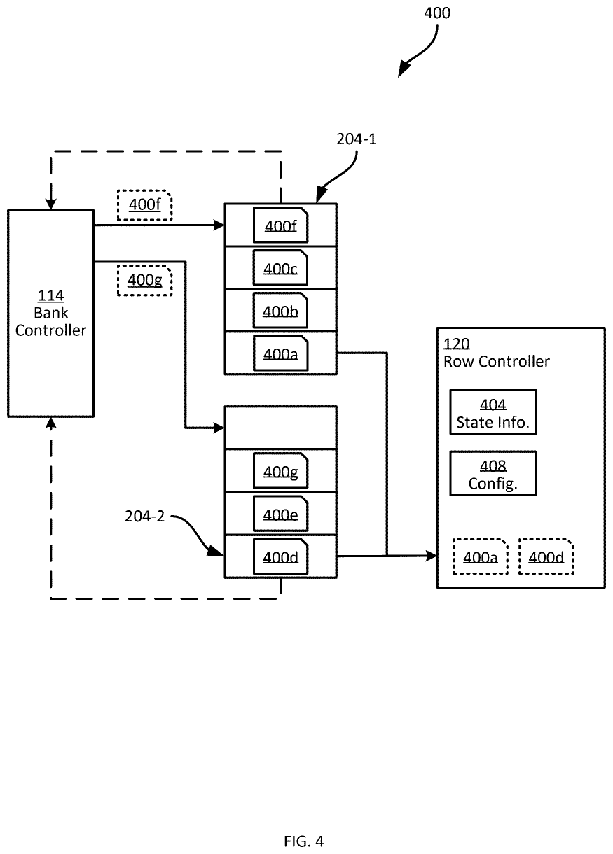

When more than one candidate command is unobstructed, the row controller 120 is configured to select a queue 204 based on a configured selection mechanic. For example, turning to FIG. 4, an example scenario is shown in which the queue 204-1 stores commands 400a, 400b, 400c, and 400f, and the queue 204-2 stores commands 400d, 400e, and 400g. The commands 400f and 400g were most recently generated by the bank controller 114, e.g., via distinct processing threads. The bank controller 114 can be configured, for example, to write commands associated with a given processing thread to one of the queues 204, and to write commands associated with another processing thread to the other queue 204. In some examples, the commands can be tagged (e.g., according to instructions in the code executed by the bank controller 114 to generate the commands) with identifiers, categories or the like, and the bank controller 114 can be configured to allocate commands to the queues 204 based on such tags.

Each queue 204 can also be configured to report state information to the bank controller 114, as shown by the dashed lines returning to the bank controller 114 from each queue 204. The state information provided by the queues 204 to the bank controller 114 can include, for example, a current capacity of each queue 204, indicating to the bank controller 114 whether the relevant queue 204 can store additional commands.

The row controller 120 can obtain the next commands from each queue 204 (e.g., the commands 400a and 400d, as shown in dashed lines within the row controller 120). Based on state information 404, the row controller 120 can determine, at block 315, whether one or more of the commands 400a and 400d are unobstructed. When the determination at block 315 is affirmative, e.g., if the command 400a is obstructed and the command 400d is unobstructed, at block 320 the row controller 120 selects one of the queues 204 based on the determination at block 315, and on configuration data 408. The configuration data 408 can indicate, for example, a queue selection mechanism to be used when more than one queue 204 is currently unobstructed. The queue selection mechanism defined in the configuration data 408 may be, for example, a round-robin configuration, such that the row controller 120 is configured to alternate between the queues 204 when more than one queue 204 is unobstructed. In other examples, the queue selection mechanism defined in the configuration data 408 can be a run-to-empty configuration identifying a particular queue 204 or ranking the queues 204. According to a run-to-empty configuration, the row controller 120 selects the identified queue whenever that queue is unobstructed, until that queue 204 is empty. Alternatively, if the configuration data ranks the queues 204, the row controller 120 can select the highest-ranked queue 204 that is currently unobstructed.

Referring again to FIG. 3, at block 325, the row controller 120 is configured to retrieve the next command from the queue 204 selected at block 320. At block 330, the row controller 120 is configured to deploy the retrieved command to the PEs 124, and update the state information 404 to reflect the deployment of the command (e.g., to indicate that the PEs 124, or certain resources thereof, are busy). For example, if the command 400d is retrieved at block 325 for deployment at block 330, the command 400d is dequeued from the queue 204, and the queue 204 would then have space for two further commands. The command 400a, meanwhile, would remain in the queue 204-1 (and the queue 204-1 would therefore be full).

As will be apparent from the discussion above, the apparatus 100, when employing multiple command queues for each row controller 120 as shown in FIG. 2B, may facilitate out-of-order execution of commands while reducing or eliminating the need for additional hardware resources and computing operations at the bank controller 114.

Although the examples described above include two queues 204 for each row controller 120, in other examples the apparatus 100 can be provided with more than two queues per row controller 120. Increasing the number of queues 204 for each row controller 120 can further reduce the likelihood of every queue 204 being obstructed, although increased queue counts may also increase the complexity associated with writing code for the bank controller 114 to execute (e.g., to provide for a higher number of processing threads, additional command tags, and the like).

The scope of the claims should not be limited by the embodiments set forth in the above examples, but should be given the broadest interpretation consistent with the description as a whole.

1. A computing apparatus, comprising:
a set of processing elements configured to execute an active command obtained from a plurality of commands;
a first command queue;
a second command queue;
a bank controller configured to place respective subsets of the plurality of commands into the first and second command queues; and
an array controller configured to:
(i) select one of the first command queue and the second command queue,
(ii) retrieve the active command from the selected one of the first command queue and the second command queue, and
(iii) deploy the active command to each of the set of processing elements for execution.

2. The computing apparatus of claim 1, further comprising:
a further set of processing elements;
a third command queue and a fourth command queue configured to receive further respective subsets of the plurality of commands from the bank controller; and
a further array controller configured to:
(i) select one of the third command queue and the fourth command queue,
(ii) retrieve a further active command from the selected one of the third command queue and the fourth command queue, and
(iii) deploy the further active command to each of the further set of processing elements for execution.

3. The computing apparatus of claim 1, wherein the array controller is configured to select one of the first command queue and the second command queue by:
obtaining state information corresponding to execution resources associated with the set of processing elements;
obtaining a first candidate active command from the first command queue, and a second candidate active command from the second command queue; and
comparing the state information with the first and second candidate active commands.

4. The computing apparatus of claim 3, wherein the array controller is further configured to:
update the state information in response to deploying the active command to the processing elements.

5. The computing apparatus of claim 3, wherein the array controller is further configured to:
determine, based on the comparison, that execution of the first candidate active command is obstructed; and
select the second command queue.

6. The computing apparatus of claim 3, wherein the array controller is further configured to:
determine, based on the comparison, that execution of the first candidate active command and execution of the second candidate active command are each unobstructed; and
select one of the first and second command queues according to a configurable setting.

7. The computing apparatus of claim 6, wherein the configurable setting corresponds to one of (i) a run-to-empty command selection configuration, or (ii) a round-robin command selection configuration.

8. The computing apparatus of claim 1, wherein the subsets of the commands are associated with respective processing thread identifiers; and wherein the bank controller is configured to:
place commands associated with a first processing thread identifier in the first command queue; and
place commands associated with a second processing thread identifier in the second command queue.

9. The computing apparatus of claim 1, wherein the bank controller is configured to receive, from first command queue and the second command queue, respective capacity indicators defining whether the command queues can store further commands.

10. A method in a computing apparatus, the method comprising:
at a bank controller of the computing apparatus, placing respective subsets of a plurality of commands into a first command queue and a second command queue of the computing apparatus;
at an array controller of the computing apparatus:
(i) selecting one of the first command queue and the second command queue,
(ii) retrieving an active command among the plurality of commands from the selected one of the first command queue and the second command queue, and
(iii) deploying the active command to each of a set of processing elements of the computing apparatus for execution; and
at the set of processing elements, executing the active command.

11. The method of claim 10, further comprising:
at the bank controller, placing further respective subsets of the plurality of commands into a third command queue and a fourth command queue;
at a further array controller of the computing apparatus:
(i) selecting one of the third command queue and the fourth command queue,
(ii) retrieving a further active command from the selected one of the third command queue and the fourth command queue, and
(iii) deploying the further active command to each of a further set of processing elements for execution; and
at the further set of processing elements, executing the further active command.

12. The method of claim 10, wherein selecting one of the first command queue and the second command queue includes:
obtaining state information corresponding to execution resources associated with the set of processing elements;
obtaining a first candidate active command from the first command queue, and a second candidate active command from the second command queue; and
comparing the state information with the first and second candidate active commands.

13. The method of claim 12, further comprising, at the array controller:
updating the state information in response to deploying the active command to the processing elements.

14. The method of claim 12, further comprising, at the array controller:
determining, based on the comparison, that execution of the first candidate active command is obstructed; and
selecting the second command queue.

15. The method of claim 12, further comprising, at the array controller:
determining, based on the comparison, that execution of the first candidate active command and execution of the second candidate active command are each unobstructed; and
selecting one of the first and second command queues according to a configurable setting.

16. The method of claim 15, wherein the configurable setting corresponds to one of (i) a run-to-empty command selection configuration, or (ii) a round-robin command selection configuration.

17. The method of claim 10, wherein the subsets of the commands are associated with respective processing thread identifiers; the method further comprising, at the bank controller:
placing commands associated with a first processing thread identifier in the first command queue; and
placing commands associated with a second processing thread identifier in the second command queue.

18. The method of claim 10, further comprising, at the bank controller:
receiving, from first command queue and the second command queue, respective capacity indicators defining whether the command queues can store further commands.
